(19) United States
(12) Patent Application Publication
(10) Pub. No.: US 2009/0120742 A1
(43) Pub. Date: May 14, 2009

(54) WEAR COMPENSATING DEVICES FOR SHOE BRAKE DEVICES

(76) Inventors: Andreas Rauch, Betzdorf (DE); Hans-Walter Treude, Wilnsdorf (DE)

Correspondence Address: HANLEY, FLIGHT & ZIMMERMAN, LLC, 150 S. WACKER DRIVE, SUITE 2100, CHICAGO, IL, 60606, US

(21) Appl. No.: 12/271,596

(22) Filed: Nov. 14, 2008

Related U.S. Application Data
(63) Continuation of application No. PCT/EP2007/004333, filed on May 15, 2007.

(30) Foreign Application Priority Data
May 16, 2006 (DE) 20 2006 007 823.1

(51) Int. Cl. F16D 65/52

(52) U.S. Cl. 188/196 D

(57) ABSTRACT

The present disclosure relates to a wear compensating device for a shoe brake having a brake lever, which brake lever supports a brake lining which acts on a brake body, and which brake lever is adjustable by an actuating arrangement about a main axis between a braking position and a releasing position. The wear compensating device has a first adjusting device which is arranged on the brake lever and which acts on a stop in such a way that the latter, as an actuating travel delimitation, acts on the first adjusting device and therefore at the same time on the brake lever and defines a corresponding releasing position. The first adjusting device has an adjusting element which engages on the stop and on which acts an adjusting force which, during braking and release of the brake, holds the adjusting element in engagement with the stop and varies the releasing position of the brake lever corresponding to the wear of the brake lining and/or of the brake body in such a way that a release gap which is set between the brake lining and the brake body remains constant. The invention also relates to a brake device having two brake levers which has a wear compensating device of said type.

### CROSS REFERENCE TO RELATED APPLICATION

This patent arises from a continuation of PCT Patent Application Serial Number PCT/EP2007/004333, filed on May 15, 2007, which claims priority to German Patent Application 20 2006 007 823.1 filed on May 16, 2006, both of which are hereby incorporated by reference in their entireties.

### FIELD OF THE DISCLOSURE

The present disclosure relate to wear compensating devices for shoe brake devices having at least one brake lever, which brake lever supports a brake lining which acts on a brake body, and which brake lever is adjustable by an actuating arrangement about a main axis between a braking position and a releasing position.

### BACKGROUND

In a braking position, the brake lining acts on a brake body, for example, a brake disk or a brake drum. In the case of industrial brakes, the braking force is applied by a brake spring which acts on the actuating arrangement. During braking, said brake spring brings the brake lever into braking position.

In order to release or disengage such a brake, a release device has been provided, which release device acts also on the brake lever by the actuating arrangement. By overcoming the brake spring tension, said release device brings the brake lever into its release position. Such a release device usually functions electromagnetically, mechanically and/or hydraulically.

During braking, i.e., during repeated actuation of the brake, the brake lining and/or the brake body wear off. As a result, the actuating path or travel of the brake lever is prolonged since the distance between the brake lining and the brake body is increased. In order to compensate this wear, a wear compensating device has been provided which wear compensating device acts upon a stop which has been defined to position the brake body. At the wear compensating device, an adjusting device adjusts the braking distance or travel in such a way that the designated release position can be defined by the impact the adjusting device has on the stop. As a result, the wear can be compensated and the braking distance/actuating path can be kept constant. At the same time, the stop and adjusting device define the releasing position of the brake arrangement.

For example, a brake arrangement featuring such a wear compensating device is known from the disk brake of type SB17MX made by the Bubenzer Company. Such a brake is specified in the corporate publication “Industriebremstechnik” [Industrial Brake Systems], second edition, of Company Bubenzer.

FIG. 10 shows such a brake in which two brake levers 50 have been provided, each of which is swivel-mounted at a mounting yoke 52. By a reference part 53, the mounting yoke 52 itself has been retained and adjusted to the brake body. At one end, the brake levers 50 support brake linings 55, and at the other end, they support the actuating arrangement 56. The stop 58 has been attached to the mounting yoke 52.

For braking, a brake spring 60 pushes the brake levers 50 apart on one end so that the other two ends, which support the brake linings 55, move toward each other in forcipate fashion and restraining the disk-shaped brake body 54 in order to brake.

In order to disengage or release the brake, the release device 62 contracts, for example, electromagnetically, the brake levers 50 by the actuating arrangement 56 so that the brake linings 55 are released from the brake body 54. The release gap is delimitated by two adjusting screws 64 which are attached at the brake levers 50 and which adjoin in releasing position of the brake with their ends the stops 58. In the event of increasing wear of the brake linings 55 or the brake body 54, these adjusting screws 64 can be adjusted, so that the wear can be compensated and the amount of the releasing gap can be kept appropriately constant. At the same time, the adjusting screws 64 are centering the position of the brake levers 50 and, consequently, the position of the brake linings 55 relatively to the brake body 54, so that the brake can be assembled in any position, without one of the brake linings 55, in released or disengaged position, resting against the brake body 54 or grinding at the rotating brake body 54.

In the example of FIG. 10, the release device acts electromagnetically. However, available are also hydraulic, mechanical, and pneumatic release devices. Such brakes are used, for example, as service brakes for crane undercarriages, swivel devices, or lifting units.

In the known brakes, it is necessary from time to time to adjust the adjusting screws 64 according to wear, in order to compensate the wear (up to 70% of the initial thickness) at the brake linings 55, because otherwise the times of incidence of the brake would change in unacceptable fashion. In other words, the so-called release gap between brake lining 55 and brake body 54 should remain as constant as possible. This manual adjustment increases the number of maintenance intervals occurring during the lifespan of a brake lining. Frequently such brakes are also located at places difficult to access, requiring extensive work of disassembly and assembly to adjust the adjusting screws 64.

A further problem consists of the fact that increasing wear results in decreasing spring tension and, consequently, decreasing braking force because of a change of the initial tension, since the position and length of the travel of the actuating arrangement to be overcome has been changed. This can also affect the function of the release device. Possibly electromagnetically induced retention forces are no longer sufficient to overcome the spring force in order to release or disengage the brake.

### SUMMARY OF THE EXAMPLES

The wear compensating device includes a first adjusting device that has an adjusting element which engages on the stop and on which acts an adjusting force which, during braking and release of the brake, holds the adjusting element in engagement with the stop and, consequently, adjusts the releasing position of the brake lever corresponding to the wear of the brake lining and/or of the brake body in such a way that a release gap L which is set between the brake lining and the brake body remains constant. In other words, by the adjacent adjusting force, the adjusting element(s) is (are) made to constantly follow up during brake operation. As a result, even if the absolute releasing position of the brake levers changes, the relative release gap (L) between brake lining, or brake linings, and brake body remains approximately constant. Consequently, the lifespan of a brake lining or brake body can be substantially utilized without additional maintenance or adjustment intervals.

In some examples, the adjusting force is applied by a spring element. As a result, the function of the adjusting device is guaranteed independent of the mounting position of the brake.

In some examples, an adjusting element is designed in cam-shaped fashion. In some such examples, a swivel-mounted cam is provided which has an adjustment surface engaging at the stop and describing a control curve which, during the transition from releasing position to braking position, compensates the wear by a pivoting movement of the cam. Here, corresponding to wear, a change of distance takes place between the working point of the adjustment surface engaging at the stop and the swivel axis (which is defined with respect to the brake lever) of the cam element. In this example, during the release process, the swivel axis of the cam is displaceably defined in the direction of the braking force relative to the brake lever, by an amount (S) corresponding to the release gap (L). This amount (S) is defined according to brake geometry and ultimately results from the leverage at the respective brake device and the designated release gap (L).

In some examples, the swivel axis of the cam runs transverse to the direction of the braking force, and the cam itself is designed in fashion of a flat cam disk. In this embodiment, the designated control curve can be developed on a plainly designed cam which can be mounted in space-saving fashion at the brake lever in the area of the stop. In some such examples, the control curve in such a cam is characterized in that the curve of the cam decreases with increasing adjustment. In this embodiment, such a control curve can be easily determined analytically or experimentally.

In some examples, the amount (S) is provided by an application of bearing defining the swivel axis of the cam, which application of bearing has two bearing elements which are adjustable to each other by the amount (S). In some examples, these bearing elements are placed torque proof and are axially fixed to the brake lever, thus defining the absolute position of the amount (S) which defines the acceptable adjustment travel of the brake levers to the stop. In some examples, a fixed bearing element has been provided which is retained toward the brake lever, and a movable bearing element which is adjustable by the amount (S) to the fixed bearing element, and which defines the relative position of the swivel axis to the brake lever and the absolute position of the swivel axis to the adjusting element or to the cam.

In some examples, a wear compensating device is employed in which a second adjusting device has been provided which acts on the brake leverage or the actuating arrangement and which is arranged and designed in such a way that it changes the effective length of the actuating arrangement corresponding to wear of the brake lining and/or the brake body to the extent that the brake spring tension and an adjusted release gap/braking distance remain constant at the brake rod. This second adjusting device guarantees that the initial tension of the spring and, consequently, the brake spring tension remains constant even if the brake linings or the brake body are wearing out. At the same time, the amount and position of the release gap at the actuating arrangement are kept constant so that the wear cannot influence the effect of the release device. By the brake lining or brake body lifespan, this second adjusting device maintains constant important brake characteristics, such as, time of incidence, braking force and release or release time.

Some examples are provided with a spindle arrangement the effective length of which, during brake operation, is being adjusted corresponding to wear through torsion of a first spindle element toward a second spindle element. Here, the second adjusting device performs the adjustment required during brake operation. Respective maintenance work is reduced and maintenance intervals are only required to exchange worn out brake linings or a worn out brake body.

In some examples, the interaction of elements occurs via linear movements performed during an actuation of the brake are converted to a respective circular motion of the first spindle element. An example brake device includes a coupling lever having guide sections such as, for example, two working sections moving together vertically.

In some examples, a brake device is provided which has two brake levers employing a wear compensating device. In such a brake device, the problems discussed above in the context of the known brake device are overcome at least partially. This example also allows the brake levers to be centered toward the brake body in their releasing position so that the brake or brake device can be used in any mounting position.

Applying the adjusting force with a spring element, which is coupled to the adjusting elements, guarantees that the process of centering is performed symmetrically since the adjusting force acts symmetrically on both adjusting elements.

### DESCRIPTION OF FIGURES

FIG. 1 is a perspective schematic illustration of an example brake device having a wear compensating device, wherein the brake device is in a braking position.

FIG. 2 illustrates the brake device shown in FIG. 1 wherein the brake device is in a release position.

FIG. 3 is a side view of the example brake device shown in FIG. 1 in a braking position.

FIG. 4 is a side view of the example brake device shown in FIG. 2 in a release position.

FIG. 5 is a cross-sectional view of the example brake device shown in FIG. 4 taken along line A-A of FIG. 7.

FIG. 6 is another view of the brake device shown in FIGS. 1 and 3, shown in the braking position.

FIG. 7 is another view of the example brake device of FIGS. 2, 4 and 5 shown in the release position.

FIG. 8 is an end view of the example brake device of FIGS. 1 through 7.

FIG. 9 is a cross-sectional a sectional view of an example application of bearing of the example braking device of FIGS. 1-9 taken along line C-C of FIG. 3.

FIG. 10 illustrates a known example brake device.

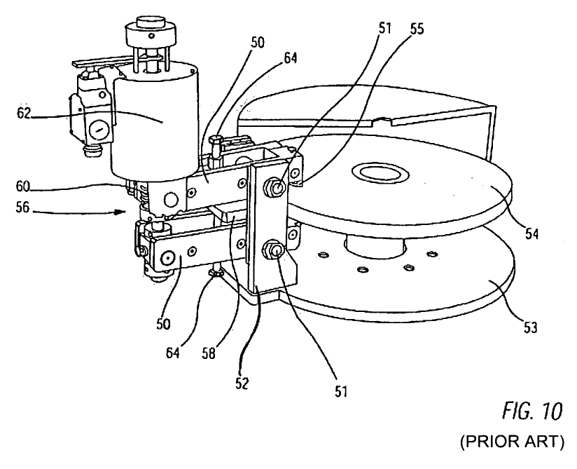

### DETAILED DESCRIPTION

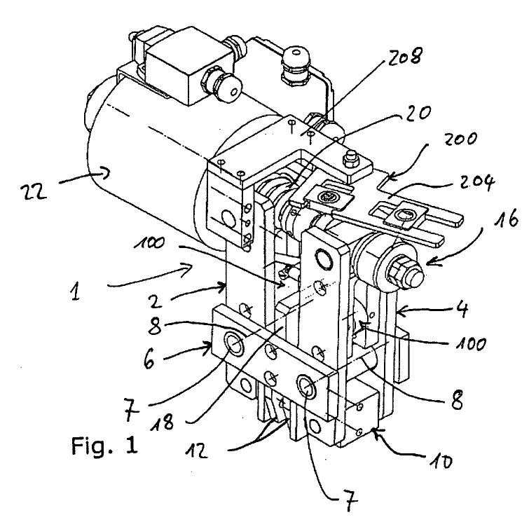

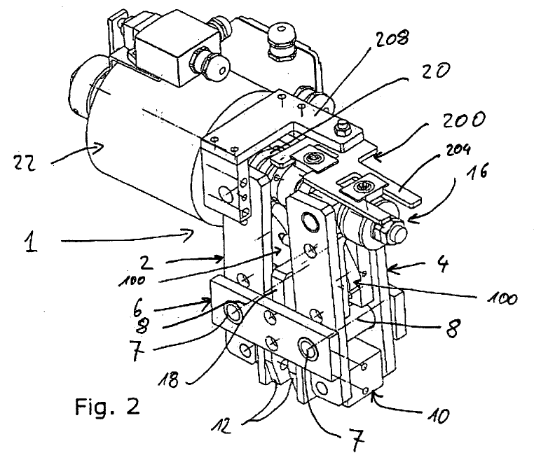

FIGS. 1 and 2 are a perspective view of an example brake device 1, which is shown in various functional positions. FIG. 1 shows the brake device in braking position and FIG. 2 in release position.

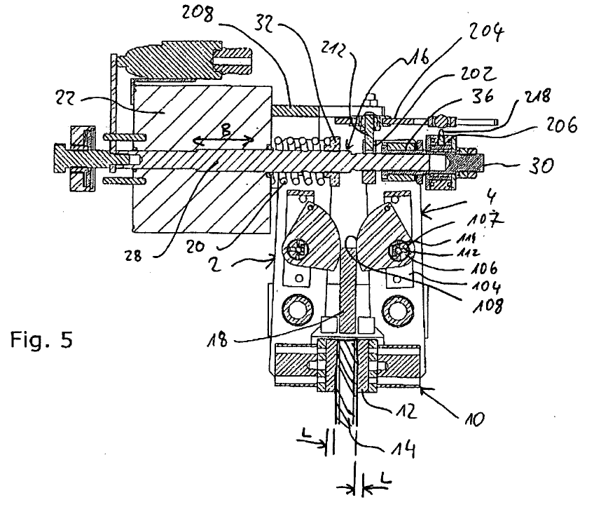

The brake device 1 has two brake levers 2 and 4 each of which consists of two lugs. The brake levers 2 and 4 are connected in flexible fashion to a yoke 6 via bolt arrangements, and are swivel-mounted in the yoke 6 about the main axes 8. At the lower end of the brake levers 2 and 4 (at the end of the shorter lever section viewed from the main axes 8), brake lining arrangements 10 have been designed in swivel-mounted fashion, respectively. Each of the brake lining arrangements 10 has a brake lining 12. A brake body 14 (shown in FIG. 5) runs between the brake surfaces of the brake linings 12 facing each other. The upper end of the brake levers 2 and 4 (at the end of the longer lever section viewed from the main axes 8) are connected to each other via an actuating arrangement 16. The yoke 6 continues to support a stop 18, which is attached at the yoke 6 in symmetrical fashion to the brake levers 2 and 4. The position of the brake device 1 is defined by the yoke 6 relative to the brake body 14. The actuating arrangement 16 comprises a brake spring 20 and a release device 22, which compresses during the process of activation the brake levers 2 and 4 by a mechanism (not shown in detail), thus disengaging or releasing the brake device 1. During the process of decelerating, the activation of the release device is cancelled or discontinued and the brake spring pushes apart the brake levers 2 and 4 so that the brake linings 12 exert a respective braking force on the brake body 14.

Each brake lever 2 and 4 is equipped with a first adjusting device 100, each of which act on the stop 18. The brake device is also equipped with a second adjusting device 200 which acts on the actuating arrangement 16. Both adjusting devices 100, 200 are used to compensate the brake lining wear and thus guarantee constant performance of the brake device during the entire lifespan of the brake linings 12 or the brake body 14.

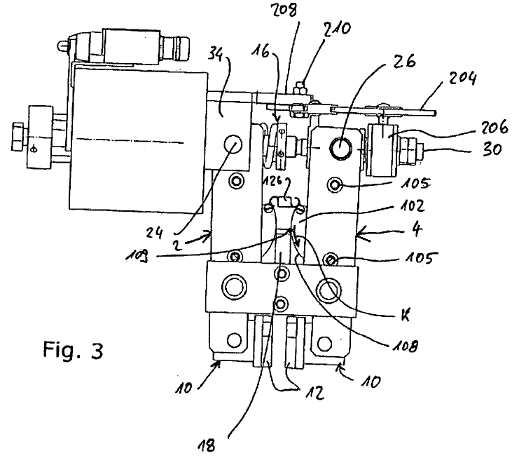

The first adjusting device 100 is described in FIGS. 3, 4, 5 and 9. Structure and function of the first adjusting device 100 are described by the first adjusting device 100 arranged at brake lever 4. The respective first adjusting device 100 at brake lever 2 is designed to be laterally reversed.

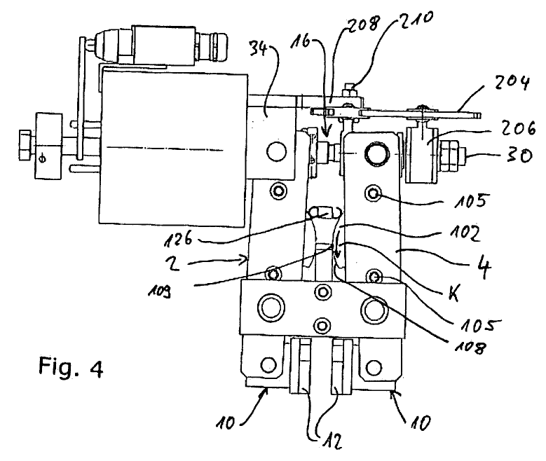

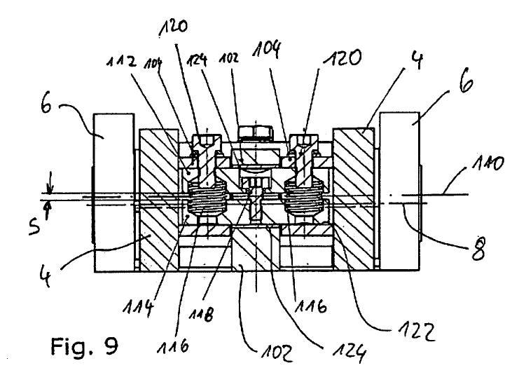

The first adjusting device 100 is designed from a cam disk 102 which is swivel-mounted at the brake lever 4 via a retaining clip 104 (FIGS. 4 and 9). In the example shown, the retaining clip 104 is attached to the brake lever 4 by mounting screws 105. However, in some embodiments, the cam disk 102 is directly housed in the brake lever 2. The cam disk 102 is mounted to the retaining clip 104 by the application of bearing 106, which penetrates an appropriate recess 107 in the cam disk 102 (FIGS. 5 and 9).

On the cam disk 102 acts an adjusting force which causes a pivoting movement in the direction of the arrow marked with K (see FIGS. 3 and 4). The cam disk 102 has an adjusting surface 108 which engages in the stop 18.

The swivel axis 110 which runs parallel to the main axis 8 is displaced in dependence of the braking position of the brake device (FIG. 9). This is achieved by the application of bearing 106 in the following way.

FIG. 9 shows a longitudinal section through the application of bearing 106. Here, a fixed bearing element 112 and a movable bearing element 114 have been provided.

Each of the two bearing elements 112, 114 have a cylindrical cup-shaped outer surface and are spaced apart by a gap S. In operation, they are forced apart by the springs 116 and are coupled to each other via the adjusting screw 118 in order to facilitate assembly and disassembly. The fixed bearing element 112 is retained in the arms of the retaining clip 104 by the mounting screws 120, namely in respective mounting openings 122. Here, the fixed bearing element 112 and the movable bearing element 114 penetrate the cam disk 102 which, via a plain bearing bush 124, swivels or pivots on the application of bearing 106.

The gap (S) defines the release gap (L) between brake lining 12 and brake body 14. The function is described in FIG. 4. Here, the brake device is described by a sectional view. For release, the brake levers 2 and 4 are compressed at the longer ends (on the top) by the actuating arrangement 16. The cam disk 102 rests against the stop 18 with its adjusting surface 108. The force applied there by the release process presses the cam disk 102 against the movable bearing element 114.

As a result, the gap S is closed against the expansion force applied by the springs 116 and the movable bearing element 114 is displaced by the amount S transverse to the swivel axis 110 and relative to the fixed bearing element 112, and the brake lever 4 (as well as brake lever 2) moves about the main axis 8 so that the brake lining is released from the brake body by the amount L.

During braking the process is reversed. If wear occurs on the brake lining 12 or on the brake body 14, a two-step adjusting process takes place: During the process of closing the brake, the brake spring 20 first pushes the brake levers 2 and 4 apart to the extent that the fixed bearing element 112 and the movable bearing element 114 are again disconnected from each other by the amount S (the position shown in FIGS. 5 and 9). If, in this position, the brake lining 12 is not yet engaged to the brake body 14, i.e., if a gap (due to wear) remains between brake body 14 and brake lining 12, the brake spring 20 pushes the brake levers 2 and 4 further apart. In the process, the adjustment surface 108 is released from the stop 18. However, the adjusting force acting in direction K causes it to pan to the extent that it rests again at the stop 18. The following release process occurs by closing the gap S in the application of bearing 106. Consequently, through a respective design of the adjusting surface 108, the wear is compensated and the release gap L between brake disk or brake body 14 and brake lining 12 is kept constant at the application of bearing 106 corresponding to the amount S of the gap.

The control curve of the cam disk 102 defining the adjusting surface 108 is designed in such a way that the cam disk 102 with increasing adjustment in the direction K has a decreasing curve so that the radial distance between the swivel axis 110 and the working point 109 of the adjusting surface 108 increases respectively at the stop 18. Here, the active pairing between stop 18 and adjusting surface 108 is designed in such a way that, with adjacent adjusting surface 108, no adjustment, i.e., no panning or moving of the cam disk 102 occurs on the application of bearing 106. Thus, the active pairing at the working point 109 is self-restricting toward forces which, possibly through the working point 109, run transverse to the main axis 8 or transverse to the swivel axis 110. An adjustment of the cam disk 102 occurs only during the actual process of braking by the adjusting force. In the example shown, this adjusting force is applied by a spring element 126, which is mounted in tension between the cam disks 102. However, the adjusting force can also be applied by a spring acting between retaining clip 104 and cam disk 102, or in any other way.

The second adjusting device 200 acts on the actuating arrangement 16 and is described in FIGS. 3 through 8. The actuating arrangement 16 is hinged at the longer ends of the brake levers 2 and 4 by respective hinge pins 24 and 26. Structure and function are also described by the sectional view in FIG. 5. The main item of the actuating arrangement 16 is the operating rod 28 which, with its one end, penetrates or extends into the release device 22 and which, with its other end, is screwed into the spindle bush 30. An adjustable stop sleeve 32 is attached to another thread section. The brake spring 20 is restrained with initial tension, which can be adjusted by the stop sleeve, between release device 22 and stop sleeve 32. The release device 22 or housing is hinged in flexible fashion to the brake lever 2 by a connecting piece 34 (see FIG. 3) and the hinge pin 24. The release device 22 shown in FIG. 5 includes a release mechanism, which is not shown and not described in any detail. Such a release mechanism can be operated in electromechanical, mechanical, hydraulic, or pneumatic fashion.

Via an intermediate bearing 36, the spindle bush 30 is hinged also in flexible fashion to the brake lever 4 by the hinge pin 26. The brake and/or release movement of the brake device 1 is occurs by a linear movement of the operating rod 28, which moves axially relative to the release device 22 in a direction depicted by arrow B in FIG. 5. During braking, the brake spring 20, supported at the housing of the release device 22, pushes against the stop sleeve 32 and pushes the operating rod 28 into the spindle bush 30, which transmits by the intermediate bearing 36, the force on the brake lever 4. As a result, the two brake levers 2 and 4 are pushed apart at the ends supporting the hinge pins 24 and 26, and said brake levers swivel toward each other about the main axes 8 at the ends supporting the brake lining arrangements 10. The brake linings 12 engage at the brake body 14.

In order to release or disengage the brake, a release mechanism (not shown) in the interior of the release device 22 acts in opposite direction on the operating rod 28. As a result, the operating rod 28 is pulled into the release device 22 against the spring force applied by the brake spring 20. In the process, via the spindle bush 30, the operating rod 28 pulls the intermediate bearing 36 in the direction of the release device 22. The ends having the hinge pins 24 and 26 of the brake levers 2 and 4 move toward each other and the ends having the brake lining arrangements 10 correspondingly move away from each other.

When wear of the brake linings 12 or the brake body 14 increases, the position of the operating rod 28 to the release device 22 changes to the extent that said operating rod 28 increasingly moves out of the release device 22 in the direction of the spindle bush 30. This reduces the initial tension of the brake spring 20 and, consequently, considerably changes important braking parameters. Because of the reduced spring force, the brake becomes softer, the braking force is reduced, and the times of incidence is increased. This adjustment takes place independent of whether or not the width of the release gap L to be bridged is kept constant by the first adjusting device 100.

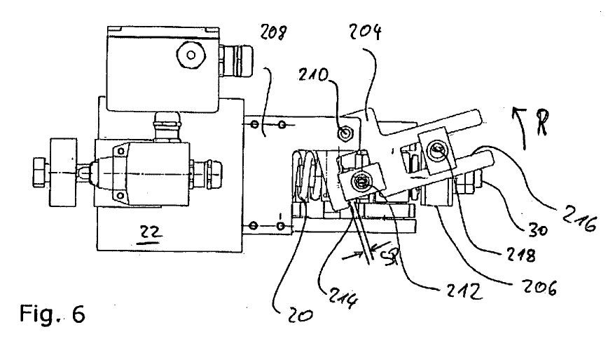

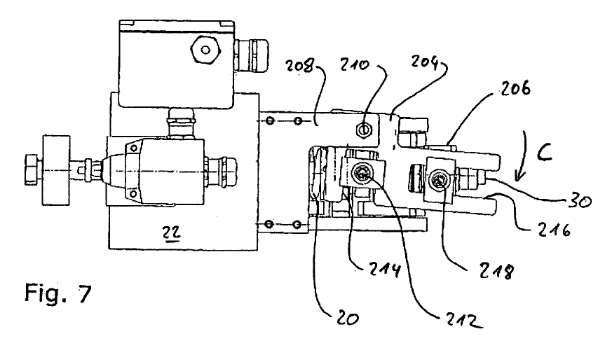

In order to keep the braking action constant, the second adjusting device 200 is provided. Said second adjusting device 200 comprises an engaging piece element 202 retained on the operating rod 28, which engaging piece element 202 is coupled by a coupling lever 204 to a freewheel assembly 206 retained on the spindle bush. FIGS. 6 and 7 show the action of the coupling lever 204, which coupling lever 204 is retained in flexible fashion in a plane by a lug coupling 208 connected to the release device 22 and which plane runs parallel to the moving direction (B) of the operating rod 28.

By the hinge arrangement 210, the coupling lever 204 is retained to the lug coupling 208 in such a way that in the center between lug coupling 208 and coupling lever 204 there is so much inhibitive friction that the coupling lever 204 independent of its mounting position does not change its swiveled position with regard to the lug coupling 208 independently.

During braking, the brake spring 20 displaces the operating rod 28 in the direction of the spindle bush 30. In the process, said brake spring picks up the engaging piece element 202 which engages with its engaging piece 212 in an adjusting fork 214 at the coupling lever 204 running approximately transverse to the moving direction (B) of the operating rod 28. By the linear movement of the operating rod 28, which is transferred to the first adjusting fork 214 by the engaging piece element 202 and the engaging piece 212, the coupling lever 204 is panned or moved about the hinge arrangement 210 in direction R (see FIG. 6). In the process, the second adjusting fork 216 engages an adjusting plug 218 at the freewheel assembly 206 and twists the adjusting plug 218 relative to the spindle bush 30.

During brake release, the operating rod 28 is retracted and the engaging piece element 202 together with the engaging piece 212 is correspondingly moved back. Here, enough clearance SP has been provided between the engaging piece 212 and the first adjusting fork 214 that, with a normal release gap, the engaging piece 212 is reset without acting on the first adjusting fork 214 or the coupling lever 204. As a result, the coupling lever 204 also does not act on the adjusting plug 218 and, consequently, also not on freewheel assembly 206 which remains in its swiveled position and which does not twist the spindle bush 30 on the operating rod 28. The clearance SP has been adjusted to the designated release gap L or the gap S in the application of bearing 106 between brake linings 12 and brake body 14. This means that in case of a systematic release gap no movement of the coupling lever 204 takes place, which movement adjusts the spindle bush 30 on the operating rod 28 by the freewheel assembly 206.

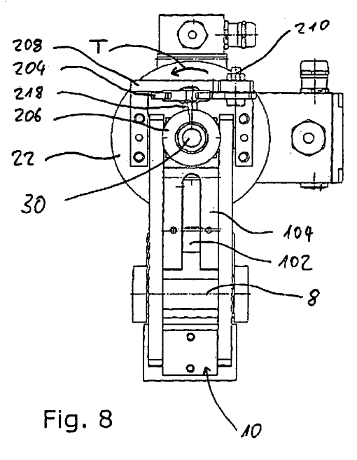

Only if, because of increasing wear of the brake linings 12 and/or the brake body 14, the coupling lever 204 is panned or moved further in the direction R by the engaging piece 212 acting in the adjusting fork 214, the engaging piece 212 acts also during release, i.e., during retraction of the operating rod 28, in the first adjusting fork 214 and pans or moves the coupling lever 204 into the position shown in FIG. 7. In the process, the second adjusting fork 216 picks up the adjusting plug 218 at the freewheel assembly 206, and the freewheel assembly 206, which is blocked in this direction, twists the spindle bush 30 on the operating rod 28 to the extent (direction T in FIG. 8) that the operating rod 28 turns the spindle bush 30 downward. This increases the actual length of the actuating arrangement 16 between the stop sleeve 32 and the connecting piece 34 so that the wear of the brake linings 12 or the brake body 14 is compensated without having changing the initial tension of the brake spring 20.

In the example shown, engaging piece 212 and adjusting plug 218 are guided by ball joints and sliding blocks, which are designed according to the adjusting forks 214, 216. Here, a guide sleeve has been provided between ball joint and sliding block which compensates the height tolerances to the pan plane of the coupling lever 204, especially during panning or moving of the adjusting plug 218. Here, the clearance SP in the first adjusting fork 214 is provided through a specific arrangement between the sliding block and the profile of the adjusting fork. Besides the arrangement shown, the interaction between the engaging piece 212 or the adjusting plug 218 and the adjusting forks 214, 216 can also take place by any other appropriate design. With corresponding geometry of the adjusting fork sides, engaging piece 212 and adjusting plug 218 can even act directly in the adjusting forks 214, 216.

In the example shown above, the first adjustment devices 100 and the second adjustment device 200 are provided at a brake device 1. This combination makes it possible to compensate up to 70% brake lining wear without changing the braking action (braking force, time of incidence). Maintenance work is reduced to a minimum.

Other examples offer the possibility to provide the first adjustment device 100 and the second adjustment device independently. This means that, in examples in which the brake body 14 is centered in relation to the brake linings 12, for example, via a specific mounting position of the brake device 1, the first adjustment devices 100 can be dispensed while the second adjustment device 200 is provided in order to provide substantially constant braking force during the entire lifespan or duration of the brake lining or brake body.

In another example, in which, for example, maintenance intervals at the brake device 1 have not been determined on the basis of brake lining wear but, instead, because of other influences, the second adjustment device 200 can possibly be dispensed if the brake lining wear to be expected is so insignificant that it cannot be expected that the wear will have an actual effect on the braking force; it is, however, desired to have a reliable wear compensating centering.

Besides the disk-shaped cams shown, it is basically also possible to use other control elements. For example, it is more or less possible that ramp or screw-shaped adjustment surfaces engage at the stop 18. With such a cam design, the swivel or rotation axis of the cam would run approximately in the direction of the braking force.

There are also other possible examples for providing the bearing gap S. For example, a spring-loaded massive bearing bolt, which replaces the fixed bearing and movable bearing elements 112 and 114, can be mounted in a respective retainer groove, which bearing bolt allows for a bearing displacement corresponding to the gap during release of the brake against the stop 18.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A wear compensating device for a brake device having a brake lever that supports a brake lining which acts on a brake body, the brake lever being adjustable by an actuating arrangement about a main axis between a braking position and a releasing position;
a first adjusting device arranged on the brake lever and which acts on a stop in such a way that the stop acts on: (a) the first adjusting device as an actuating travel delimitation and (b) on the brake lever to define a corresponding releasing position,
the first adjusting device having an adjusting element which engages on the stop and on which acts an adjusting force which, during braking and release of the brake, holds the adjusting element in engagement with the stop and varies the releasing position of the brake lever corresponding to the wear of the brake lining and/or of the brake body in such a way that a release gap which is set between the brake lining and the brake body remains constant.

2. A wear compensating device according to claim 1, in which the adjusting force is applied by a spring element.

3. A wear compensating device according to claim 1, in which the adjusting element comprises a swivel-mounted cam, the adjusting surface of the cam engages at the stop and describes a control curve which, during the transition from the releasing position to the braking position, compensates the wear by a pivoting movement of the cam, wherein a change of distance takes place between the working point of the adjustment surface engaging at the stop and the swivel axis of the cam element.

4. A wear compensating device according to claim 3, in which, during the release process, the swivel axis of the cam is displaceably defined in the direction of the braking force relative to the brake lever, by an amount corresponding to the release gap.

5. A wear compensating device according to claim 3, in which the swivel axis of the cam runs transverse to the direction of the braking force, and the cam is designed in fashion of a flat cam disk.

6. A wear compensating device according to claim 5, in which the curve of the control curve decreases with increasing adjustment.

7. A wear compensating device according to one of claims 3, in which the cam is pivoting on an application of bearing defining the swivel axis and which application of the bearing has two bearing elements which can be adjusted toward each other.

8. A wear compensating device according to claim 7, in which the bearing elements are placed torque proof and are fixed axially to the brake lever.

9. A wear compensating device according to claim 7, in which a fixed bearing element and a movable bearing element have been provided, whereas the fixed bearing element has been retained relative to the brake lever, and the movable bearing element is adjustable by the amount to the fixed bearing element and defines the swivel axis.

10. A wear compensating device according to claim 1 in which a second adjusting device has been provided which acts on an actuating arrangement which transfers brake spring tension, which is coupled to a release device, and which acts on the brake lever, and which is arranged and designed in such a way that it changes the effective length of the actuating arrangement corresponding to wear of the brake lining and/or the brake body to the extent that the brake spring tension and an adjusted release gap remains constant at the actuating arrangement.

11. A wear compensating device according to claim 10, in which the actuating arrangement acts between two brake levers and which actuating arrangement has a spindle arrangement which is designed in such a way that, during brake operation, the second adjusting device adjusts the effective length of the actuating arrangement corresponding to wear through torsion of a first spindle element toward a second spindle element.

12. A wear compensating device according to claim 10, in which the second adjusting device converts, via respective engaging piece elements, a linear movement of the actuating arrangement performed relative to one of the brake levers, into a circular motion of the first spindle element, whereas the engaging piece elements interact via respective coupling elements.

13. A wear compensating device according to claim 12, in which the coupling elements comprises a swivel-mounted coupling lever the swivel axis of which has been defined with regard to its position of a brake lever, and in which the coupling lever has approximately two working sections running together vertically, each of which interacts with the engaging piece elements.

14. A wear compensating device according to claim 1, wherein the Brake device has two brake levers which have a wear compensating device.

15. A brake device according to claim 14, in which both brake levers have a first adjusting device, whereas the first adjusting devices center the brake levers in their respective release position relative to the brake body at the stop

16. A brake device according to claim 13, in which the adjusting force is applied via a spring element coupled with the adjusting elements.
